(19) United States
(12) Patent Application Publication
(10) Pub. No.: US 2006/0101112 A1
(43) Pub. Date: May 11, 2006

(54) Method for providing services via a communication network

(76) Inventor: Hubertus Von Savigny, Freigericht (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/545,025

(22) PCT Filed: Feb. 11, 2004
(86) PCT No.: PCT/EP04/01269

§ 371 Date: Oct. 4, 2005

(30) Foreign Application Priority Data
Feb. 11, 2003 (DE) 103 05 771.4

(51) Int. Cl. G06F 15/16

(52) U.S. Cl. 709/203

(57) ABSTRACT

The invention relates to a method for providing services, preferably telecommunication and/or Internet services, via a communication network. A communication link (3) is set up between a host (2) and at least one client (4) of a user. A request from a user for the provision of a service via a client (4) is sent to a host (2). The host (2) communicates with a plurality of service provider clients (5,6,7). In order to reduce the processing time for the service and to increase the quality of the service thus provided, the services of the supplier are evaluated according to service-specific quality parameters by the host (2) and/or user and/or by third parties. Suppliers are automatically ranked by the host (2) on the basis of said evaluation. The host (2) provides the suppliers with the authorization and/or opportunity to offer or provide the requested service automatically according to their ranking priority.

The invention concerns a method for providing services over a communications network according to the preamble of claim 1. Furthermore, the present invention concerns a system for providing services over a communications network, preferably telecommunication and/or internet services.

A method and a system for providing services over the internet is already known from practice. In the known system, questions on a number of fields of knowledge are answered by so-called experts. After producing a communication link between a client and a host, a question is asked of the host by the user via the client. The question asked by the user via the client is displayed on a page of the host and can be read and possibly answered by other clients who likewise produce a communication link with the host. In order to be able to answer the questions with qualified answers in the shortest possible time, the known method provides that the additional users can read more or less simultaneously via the additional clients the question asked via the clients and mediated or forwarded by the host and have themselves registered with the host as so-called logged-on answerers for the question, in which case only a predefined and limited number of additional users are granted the status of a “logged-on answerer” to answer the question which has been asked. As a result, the circle of potential answerers is broadened to all users of the system, and they have the possibility of reading the questions asked online and answering them online, i.e., directly. However, not just any user is designated or entitled to answer the question asked. In the familiar method, there is an automatic limiting of the number of logged-on answerers by an appropriate status assignment, which is accomplished by the host. Thanks to this measure, a competitive situation is created among the additional users who wish to acquire the status of logged-on answerer, which generally results in a situation where additional users often log on as answerer immediately after a question is asked, in order to be granted the status of logged-on answerer. The status of logged-on answerer involves the receiving of a fee or the like after answering the question. The amount of the fee depends on the evaluation by the user of the search result or the answer from the particular answerer. In this way, the user can exercise a self-regulating influence on the quality and efficiency of the answering of a question. As a result, the questions asked are answered at once and generally with high quality.

The problem of the present invention is to provide a method and a system of the above-mentioned kind in which requested services are provided in the shortest possible time and with high quality.

The stated problem is solved by the features of claim 1 in a method of the kind mentioned above.

The requested service is transmitted by the user to the host, while the requested service is displayed on a page provided by the host or can be retrieved via the provider clients and/or is transmitted to the provider clients. The invention allows a provider with a high level in the ranking or with high values for the quality parameters specific to the service to offer or to provide the requested service before a lower-level provider, or to be otherwise privileged with respect to the lower-level provider. This can be done, for example, in that all providers simultaneously learn of the requested service and can transmit their offers on a page provided by the host. The host can then automatically steer the forwarding of the offers to the user in accordance with the ranking of the providers or display the offers to the user in accordance with the ranking (staggered in time). It is also possible in theory for the requested service to be transmitted to the particular provider clients by the host with an automatic time staggering depending on the ranking of the providers, and thus the providers can learn of the requested service one after the other according to their ranking. In this case, the providers can transmit the offers to the host or also directly to the client. This has a very positive impact on the quality of the service provided.

Finally, the host in the invention performs an automatic mediating function between the user and the providers and a selection function from among the individual providers. It should also be pointed out that the host is a device in the manner of a central computer. This can be constituted by an individual computer or a number of interlinked computers. The client is likewise a device having computer hardware, such as a PC, laptop, PDA, mobile telephone, etc. It should also be pointed out that the term “client” and “provider client” means not just the particular computer unit as such, but also the corresponding software and hardware, including in particular keyboards, as well as displays, monitor screens, or the like, on which the relevant information is indicated.

If a remuneration is provided by the “first come-first served” principle only to those providers who first offer or provide a service, each provider will strive to occupy the highest possible level in the ranking of all providers, so that they can be permitted to offer or provide the service ahead of a competing provider. However, a high level in the ranking is only given to those providers which have received a relatively good evaluation (ranking) by the host or user after providing the service. This motivates the providers to offer and to provide a requested service such that their evaluation in terms of given quality parameters specific to the service turns out to be relatively good. The same holds when the compensation is staggered in regard to the ranking or in regard to the provider's grade for the quality parameters specific to the service.

Moreover, it is to be noted that the “providing” of services via a communications network can entail not just providing of information, although the prior art mentioned above concerns a method for providing information via a communications network. Other possible areas of application of the invention also involve, for example, activities in the realm of word processing or text translation. Basically, the providing of services over a communications network can involve any form of services that can be offered by a plurality of providers and are requested anonymously for the user through the communications network. But the area of use which is preferred is that where the user has a particular question and the providers indicate to the user a suitable internet page which can answer the question of the user.

It is essentially possible to include all providers communicating with the host in their ranking and thus in sequence. But it is also equally possible to perform a preliminary classification of the providers in the manner of an access hurdle in order to limit the number of providers admitted and logged on, preferably in automatic fashion. For this, the host can assign status, for example, as is already familiar from the aforesaid prior art, to which express reference is made. It is preferable for the host to automatically limit the number of providers per question, specifically, to 2-10 providers, preferably 3-5 providers. In this connection, it is of special advantage if the service can only be provided by those providers who have previously obtained the status of a “logged-on provider.” A “logged-on provider” is one who has received approval from the host to make an offer for a specific inquiry, it being necessary, of course, for each provider to register ahead of time with the host, and this can only be done with permission from the host or the host's operator. Thanks to the assigned status, the “logged-on provider” has, for example, the right to access the incoming offer page of the host, which non-logged-on providers cannot do. It is also of special advantage in this connection that the logged-on providers participating in the method of the invention are shown, preferably in real time, the number of logged-on providers for their provider clients or the number of providers authorized to perform a particular service. This will create a transparent competition situation for the individual providers. Furthermore, it is worthwhile granting a logged-on provider a reservation time during which he will be able to provide the particular service. Within this reservation time, it is not possible for another provider to get ahead of him.

The providers designated or approved for providing the service can be evaluated by the host automatically and/or by the user and/or by third parties. The determination of the ranking level and the sequence is then done automatically by the host, so that the user can always be shown a favored selection of all providers designated or approved for providing the service. This has a positive impact on the willingness of the customer or the user to make use of the method of the invention and also to accept the response offered to their query. In this connection, it is also possible for the user to be able to decide which of the displayed high-ranking providers should ultimately provide the service. The decision of the user can be made, for example, on the basis of the evaluation or the service-specific quality parameter values of a provider or a specific advertisement from each approved provider. Preferably, however, the host will automatically select one or more high-ranking providers to provide the requested service. In this case, the user himself preferably has no selection option, which substantially simplifies the method for the user.

The method of the invention is furthermore distinguished in that providers with comparatively poor service-specific quality parameter values, which is tantamount to a worse reliability and/or a worse qualification of the particular provider for the providing of a service, have a comparatively lower chance of providing a requested service. Providers with a low ranking are therefore disadvantaged and/or may be totally excluded from the ranking or the evaluation of ranks. This means that a motivation is created for all service providers to achieve the best or highest possible service-specific quality parameter values, which is possible for example by providing services of high quality. Furthermore, this promotes quality consciousness and concern for the customer among all service providers.

The invention allows the providers to be privileged in accordance with their particular level in the ranking, which occurs for example in that the providers are designated one after the other for providing or offering the service, according to their level in the ranking. The term “one after the other” can mean, on one hand, that only the highest ranking provider(s) can provide the service at first. Only afterwards can the providers coming after the highest provider in the ranking with a comparatively lower ranking provide the service or make an offer to the user. Basically, however, it is also possible to designate a certain number of providers to simultaneously provide the service, and the ranking is used to select the ones with the highest ranks from among the available providers. Other forms of privileging are also possible. In the final analysis, a preference is granted to the higher rankings over the lower rankings—as in a wolf pack.

A preferred embodiment of the method of the invention calls for assigning the providers in accordance with their particular ranking to at least two different qualification classes or groups with different ranking, and providers from a high-ranking qualification class are designated before the providers of a lower-ranking qualification class to provide or offer the service. According to the invention, the different qualification classes each contain providers from a particular range of the sequence. The qualification classes are used to divide up the total number of providers included in a sequence into discrete partial ranges with providers of different qualification. The qualification classes as such can likewise be arranged in the manner of a sequence, and the ranking of the qualification class will depend on the content of the qualification class or the ranking of the providers in the qualification class. In the most simple case, the host at first assigns all providers to one qualification class. After evaluating the services of the providers and determining the individual rankings and then the sequence of all providers, a separation of the providers in accordance with the ranking or the sequence can be done, with high-ranking providers assigned to a first qualification class and lower-ranking providers to a second qualification class.

In order to further enhance the quality in the providing of services and give the providers incentives and a greater motivation to improve performance, the invention also allows providers with a high ranking, preferably those with the highest ranking, to be designated at once to provide the service and providers with a comparatively lower ranking to be designated only to provide the service after a timeout expires, or staggered in time by the duration of the timeout, which is done automatically by the host. Basically, the most qualified providers receive a time advantage over the less qualified providers. Once again, the qualification of the providers is judged by means of service-specific quality parameters. The host will automatically impose a timeout between two providers of different ranking so that the lower-ranking provider can only respond afterwards to the service request of the user or the request will only be forwarded to a lower-ranking provider at a later time. This has the effect that the particular providers are not designated at the same time to offer or provide a service, but rather with time staggering. If remuneration is given only to the providers which are first to perform the service, the timeout will constitute a high incentive to all providers to occupy the highest possible level in the ranking.

Of course, it is equally possible to designate at once the providers from a high-ranking qualification class, preferably the highest ranking one, to provide the service, and providers from a comparatively lower-ranking qualification class can only provide the service or offer the service after the timeout expires. This essentially means that a timeout is imposed between two qualification classes of different ranking. In this way, for example, all the providers assigned to the first qualification class could offer or provide the service at once (and with equal chances among themselves), while the providers of a lower-ranking qualification class would have to wait for the timeout to expire before being able to offer or provide the service.

Preferably, in order to evaluate the providers or determine the ranking sequence, service-specific quality parameter values of several providers are compared to each other by the host and/or service-specific quality parameter values of the providers are compared to certain setpoint values. This makes possible, on the one hand, a comparative evaluation among several providers who are vying to provide a requested service. It is equally possible, of course, to evaluate the providers by means of standardized evaluation criteria. Thus, either a relative evaluation of the providers or an absolute evaluation of providers by the host is essentially possible.

In order to continuously heighten the motivation of the providers and the quality of the service performed by the particular provider, it is preferable that the evaluation of the providers or the determination of the ranking sequence be done on the basis of a plurality of service requests and/or a plurality of services provided. Essentially, of course, it is also possible to evaluate the providers already after one service is provided. Naturally, with an increasing number of evaluation steps, the qualification of the providers can be judged increasingly better. In particular, individual services provided with very high quality or very low quality will not be overweighted, but averaged out.

Preferably, the evaluation of the service of a provider is based on time and/or quality and/or quantity averaging of the service-specific quality parameter values of the particular provider. In this way, the provider can be evaluated over a rather lengthy time and/or relative to other providers and/or absolutely in terms of predetermined setpoint values. This contributes to the high information content of the provider evaluation used in the method of the invention.

The evaluation of the providers to determine the ranking or the privilege granted by the host, especially by imposing a timeout, can be done, for example, on the basis of

the number of services provided,

the availability of the service provider, preferably in terms of the online time of the provider, determined within a reference period,

the number of service offers submitted by the particular provider,

the number of service requests handled,

the number of service requests read,

the percentage of accepted service requests in relation to the service requests read,

the percentage of services provided,

the extent of the services provided,

the percentage of services provided in comparison to other providers,

the average time span up to acceptance of the service,

the average processing time to provide the service after acceptance,

the average time span until the results of the service reach the user or the host,

the percentage of services provided that are deemed “unusable” or “deficient” or the like by the user or by the host,

the average grade of one or more service-specific parameter values within a reference period and/or a particular type of services,

the average grade determined from at least one service-specific quality, determined at periodic intervals or by random selection of individual quality parameter values of the provider, and/or

a complex characteristic made from at least two of the aforementioned service-specific quality parameters.

Even though the providers are designated one after the other in accordance with the particular ranking in the sequence to provide or offer the service, it is advisable, in order to further enhance the quality of the services provided, to simply not designate providers with a very low ranking or those from a very low qualification class to offer or provide the service. For example, the timeout for such providers can be extended so much beyond the providers of higher ranking that it is generally no longer possible for such a provider to offer or provide the services, for example, because the requested service has already been provided.

The length of the timeout can be set in dependence on the ranking of the qualification class and/or the ranking of the provider. Basically, it is also possible to set the length of the timeout individually for a provider. This offers the advantage that particularly qualified providers can be more heavily favored by the host and nonqualified service providers can be assigned an individual time penalty. This is of advantage, for example, when additional circumstances are at play, beyond just the evaluation of the provider in terms of service-specific quality parameters, such as to justify an even more severe penalization of a lower-ranking provider as compared to the other providers. The individually set timeout can also result in the excluding of certain providers from the general population of providers.

Furthermore, the length of the timeout can also be set in dependence on the ranking distribution and/or the total number of providers (who happen to be online) and/or the number of providers in a qualification class. This has the result of setting the time delay relative to the providers who are logged on or are generally approved to provide the service in the specific case. For example, if a high-ranking provider drops out for any reason, or if several services are requested at the same time, the timeout of a lower-ranking provider may be shortened or even totally lifted. The important thing is that the timeout should not lead to a needless delay in providing or offering the service.

In order to constantly update the evaluations of the individual providers and respond in a flexible way to changes in the quality of the services provided or changes in the qualifications of the individual providers, it is advantageous according to the invention to reevaluate the providers after each service performed. Naturally, the evaluation can also be done after several services are offered or performed, and/or periodically.

In order to heighten the competitive situation among the providers and thereby improve the weeding out of unqualified providers, it is preferable according to the invention that the requested service be displayed at the same time to all providers, and this in real time. When all providers learn of the requested service at the same time, according to the invention, providers with a lower ranking or those from a lower qualification class can only offer or provide the service after the timeout expires, but at least after the higher-ranking providers. After the timeout expires, the particular provider can then offer or provide the requested service without any further delay.

In order to strengthen the competitiveness of the providers for a high ranking and thereby ensure a high level of quality of services provided, a provider is shown the qualification class pertaining to him and/or other providers, and/or the ranking sequence, and/or the service-specific quality parameter values. It is likewise possible to show a provider the length of the timeout and/or the remaining time until the timeout expires and/or the evaluation. This will increase the motivation of the provider to boost his own performance, since it is possible for the provider to compare his performance directly with the performance of competing providers and take appropriate steps to rise in the rankings. Of course, it is also possible to give the user a glimpse into the qualification of a provider. For example, the user can himself decide which of the service-specific quality parameters are of special interest to the service which he requires. In this connection, the invention basically allows the user to carry out an individual weighting of the evaluation of the provider.

When a provider has been subject to a timeout for a particular time, a signal characterizing the expiration of the timeout can be presented to the particular provider to notify them as to the imminent expiration of the timeout. For example, it is possible to configure the communication link between the host, the client, and the provider clients in such a way that a service request of the user will be displayed directly to the provider client of a blocked provider or to the host with a marking. The marking notifies the respective provider that he is blocked in providing the requested service. In order to notify the blocked provider as to the end of the timeout, the marking can change to a blinking signal, for example. A change in color, for example from red to green, is also possible. In this case, the blocked provider knows that he can offer or provide the requested service within a short time.

The invention shall now be described by means of the drawing, for example, for a method of providing information via a communications network, without restricting the general notion of the invention. This shows:

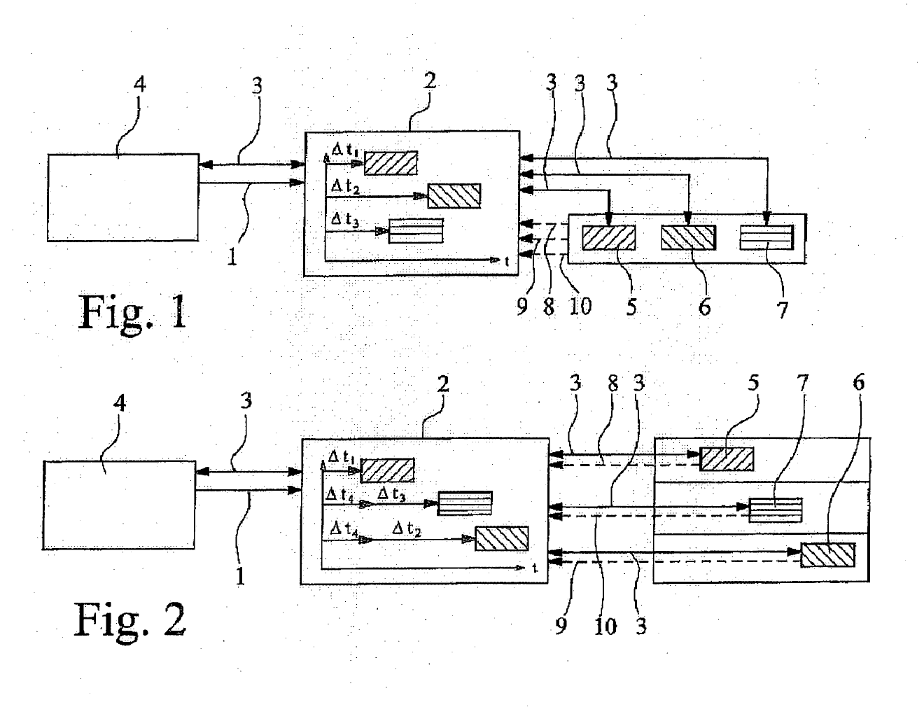

FIG. 1, a system for providing services across a communications network at a time tₙ,

FIG. 2, the system represented in FIG. 1 at time tₙ₊₁.

In FIGS. 1 and 2 a system is represented for providing information via a communications network, particularly the internet. In the present instance, the service being provided or offered is answering a question 1. The system has a host 2, which communicates via a communication link 3 to a client 4 of a user. The communication link 3 can be, for example, the internet. Of course, the communication link can also essentially be any wired or wireless link, such as a radio link. Furthermore, the host 2 communicates with provider clients 5, 6, 7 likewise via communication links 3. For example, it may happen that, after establishing the communication link 3 between the client 4 and the host 2, a question 1 is asked of the host 2 by the user through the client 4 in order to obtain information, whereupon the question 1 asked via the client 4 is displayed on an answer page of the host 2. By means of the communication links 3 provided between the provider clients 5, 6, 7 and the host 2, the question 1 displayed on a page of the host 2 can be read and answered by the answerers 1 [sic] assigned to the provider clients 5, 6, 7. In the meaning of the invention, the answerers involve the providers of the service “answering a question 1.” In order for the answerer/provider to be able to answer the question 1, there preferably occurs a preceding registration of the provider, which makes it possible to access the otherwise inaccessible answer page of the host 2.

FIG. 1 shows the system at time tₙ, when the user has asked a question 1 via the client 4 to the host 2 for the first time. In reply to the question 1, answers 8, 9, 10 from answerers are transmitted via the provider clients 5, 6, 7 to the host 2 and displayed on another page of the host 2. The transmittal of the answers 8, 9, 10 coming from the provider clients 5, 6, 7 to the host 2 constitutes in the present case the providing of the service “answering a question 1.” Usually, answering question 1 is done by designating a suitable internet page, indicating the respective internet address.

According to the invention, the communication links 3 between the host 2, the client 4 and the provider clients 5, 6, 7 are configured such that the answerers or service providers can be evaluated by the host 2 and/or by the user and/or by third parties in terms of given service-specific quality parameters. The answers 8, 9, 10 in the system described here each contain search results for the question 1 asked by the user via the client 4 and can have a plurality of researched results. Furthermore, the answers 8, 9, 10 can be provided with a commentary from the answerer. The service-specific quality parameters used to evaluate the answerer or service provider can be, for example

the number of search results or the number of answers 8 or 9 or 10 that an answerer transmits to the host 2,

the online time, measured relative to a reference period, during which the answerer maintains the communication link 3 between the host 2 and the particular provider client 5, 6, 7,

the number of questions 1 read by an answerer,

the percentage of questions 1 processed by the answerer in relation to the questions 1 displayed at the host 2,

the percentage of answers 8, 9, 10 provided with a commentary,

the extent of the commentary provided,

the percentage of questions 1 answered before other answerers or exclusively by one answerer,

the average length of time until the decision of an answerer to answer a question 1,

the average processing time to answer the question 1,

the average time it takes for the search result or answer 8, 9, 10 to reach the host 2,

the percentage of search results or answers 8, 9, 10 deemed “wrong” or “unusable,”

the average grade, for example, determined from every third search result of a provider,

a characteristic formed from at least two of the above-given service-specific quality parameters, and/or

the average grade from a plurality of evaluated service-specific quality parameters and/or the average grade within a reference period and/or a subject area.

According to FIG. 1, the service-specific quality parameter is the processing time Δt₁, Δt₂, Δt₃ that is required by the particular provider to answer the question 1 after it is asked by the user. FIG. 1 represents the system at time Δtₙ, at which the user has for the first time asked a question 1 of the host 2 via the client 4 for answering. The question 1 can be read by all answerers at the same time, for example. All answerers are at the same ranking. The answers 8, 9, 10 provided via the provider clients 5, 6, 7 are transmitted to the host 2, where they are displayed to the user at differing speed, depending on the individually varying processing time of the particular answerer. Thus, the answer 8 is displayed after a time span Δt₁, the answer 9 after a time span Δt₂, and the answer 10 after a time span Δt₃. Since, in the present instance, the processing time of the answerers has been chosen as the service-specific quality parameter, the answerer belonging to the provider client 5 has answered the question 1 the fastest, while the answerer belonging to the provider client 6 has answered the question 1 the slowest. If a remuneration is provided, for example, only for the two fastest answerers, the answerer belonging to the provider client 6 will receive no remuneration. Thus, each answerer has the initial goal of answering the question 1 as fast as possible.

According to the invention, service-specific quality parameter values of the answerers, in the present case the processing time to answer the question 1, are compared to each other or to established setpoint values. This can occur automatically by the host 2, for example. Furthermore, it is also possible for the user to directly evaluate other service-specific quality parameters through the client 4. An evaluation by a third party is also essentially possible. On the basis of the evaluation, a level or particular ranking value is automatically determined by the host 2 for each individual answerer/provider and then a ranking sequence for the answerers is determined.

FIG. 2 shows the system at state tₙ₊₁, i.e., after the evaluation of the answerers has been done by the host and/or by the user and a ranking has been produced. The ranking in the present case means that the answerers belonging to the provider clients 5, 6, 7 are permitted to provide the service in accordance with their particular ranking in the sequence. For example, the question 1 can only be displayed to the lower-ranking answerer in the sequence after it has been displayed to the higher-ranking answerer. But basically any other type of privileging of the higher-ranking answerer over the lower-ranking answerer is also possible. In the present case, the answerer belonging to the provider client 5 occupies the highest ranking, while the answerer belonging to the provider client 6 occupies the lowest ranking in the sequence. If the user through the client 4 again asks a question 1 of the host 2, the highest-ranking answerer belonging to the provider client 5 according to the ranking sequence can read the question 1 first, while the answerer belonging to the provider client 6 is shown the question 1 last. The answerer belonging to the provider client 5 thus obtains a time advantage over the lower-ranking answerers, which helps him keep the processing time comparatively low for answering the question 1. This leads to a rewarding of the highest-ranking answerer, associated with a motivation of the lower-ranking answerers to improve their performance.

In an especially preferred embodiment of the invention, according to FIG. 2, providers with a comparatively low ranking are only designated to provide the service after expiration of a timeout. This means that the time staggering between providers with different ranks in the sequence is increased. Thus, depending on the sequence, the providers are designated to provide the service not immediately one after the other, but staggered by the timeout. It is assumed in FIGS. 1 and 2 that the processing times Δt₁, Δt₂, Δt₃ to answer the question 1 are unchanged.

The answerer with the highest ranking according to FIG. 2, i.e., the answerer belonging to the provider client 5, is the first one who can read and answer the question 1. The answerers belonging to the provider clients 6, 7, however, can only read and answer the question 1 after expiration of the timeout Δt₄. The timeout Δt₄ is chosen to be of equal length in the present case, but it can also be assigned dependent on the ranking of an answerer or even individually. Preferably, the timeout is automatically imposed by the host 2. The answers 9, 10 are therefore indicated to the host 2 or to the client 4 with a delay by the processing time Δt₄+Δt₂ and Δt₄+Δt₃.

This has the consequence that each provider will do its best to occupy the highest possible ranking in the sequence, for fear of a timeout. Thus, the overall quality of the answers or the search results will be substantially improved.

The incentive to occupy a high ranking in the sequence stems, for example, from the fact that the evaluation of the answerers or the timeout can have direct impact on the remuneration. Furthermore, it is also possible that only a limited number of answerers will receive remuneration, while the answerers responding to a question 1 later do not receive any remuneration. The pressure on the answerers to perform is substantially intensified by the timeout, which has a positive impact on the quality of the service provided.

1. A method for providing services, preferably telecommunication and/or internet services, through a communications network, wherein a communication link (3) is established between a host (2) and at least one client (4) of a user, wherein a request from a user for providing a service is transmitted via a client (4) to the host (2) and wherein the host (2) communicates with a plurality of provider clients (5, 6, 7) of service providers, characterized in that the services of the providers are evaluated in terms of service-specific quality parameters by the host (2) and/or by the user and/or by third parties, and a ranking sequence of the providers is automatically determined by the host (2) on the basis of this evaluation, and the host (2) automatically grants to the providers the approval and/or possibility of offering or providing the requested service depending on their particular ranking.

2. The method according to claim 1, wherein the providers are assigned in accordance to their particular ranking to at least two different qualification classes with different ranking, and providers from a higher-ranking qualification class are designated before the providers of a lower-ranking qualification class to provide or offer the service.

3. The method according to claim 2, wherein at least one provider with a high ranking, preferably with the highest ranking, is designated at once to provide the service, and providers with a comparatively lower ranking are only designated to provide the service after a timeout expires.

4. The method according to claim 3, wherein at least one provider from a high-ranking qualification class, preferably the highest ranking one, is designated at once to provide the service and providers from a comparatively lower ranking qualification class are only designated to provide the service after a timeout expires.

5. The method according to claim 4, wherein the requested service is either displayed to a lower-ranking provider and/or can be called up by the lower-ranking provider after a timeout, or the request for the service is forwarded at once and the lower-ranking provider can provide the service after the timeout, or a service provided at once by a lower-ranking provider is forwarded to the client after the timeout.

6. The method according to claim 5, wherein, in order to evaluate the providers and/or determine their ranking, service-specific quality parameter values of several providers are compared to each other and/or service-specific quality parameter values of the providers are compared to fixed setpoint values.

7. The method according to claim 1, wherein the evaluation or the determination of the ranking is done automatically on the basis of a plurality of service requests and/or a plurality of services provided.

8. The method according to claim 1, wherein the evaluation or the determination of the ranking is done automatically on the basis of time and/or quality and/or quantity averaging of the service-specific quality parameter values.

9. The method according to claim 1, wherein the length of the timeout and/or the degree of handicapping is determined individually and/or in dependence on the ranking of the qualification class and/or the ranking of the provider.

10. The method according to claim 1, wherein the length of the timeout is determined in dependence on the ranking distribution and/or the total number of providers and/or the number or providers in a qualification class and/or the number of providers online at the time of the inquiry.

11. The method according to claim 1, wherein the services of the providers are reevaluated after each service is provided.

12. The method according to claim 1, wherein the service request is displayed to all providers at the same time.

13. The method according to claim 1, wherein the provider is shown the evaluation and/or the qualification class and/or the ranking sequence and/or service-specific parameter values and/or the length of the timeout and/or the remaining time until the timeout expires.

14. The method according to claim 1, wherein a signal characterizing the expiration of the timeout is presented to the provider.

15. A system for providing services through a communications network, preferably telecommunication and/or internet services, having a host (2) connected by communication links (3) to a client (4) and a plurality of provider clients (5, 6, 7) to carry out the method according to claim 1.

16. The method according to claim 1 wherein at least one provider with a high ranking, preferably with the highest ranking, is designated at once to provide the service, and providers with a comparatively lower ranking are only designated to provide the service after a timeout expires.

17. The method according to claim 2 wherein at least one provider from a high-ranking qualification class, preferably the highest ranking one, is designated at once to provide the service and providers from a comparatively lower ranking qualification class are only designated to provide the service after a timeout expires.

18. The method according to claim 1 wherein the requested service is either displayed to a lower-ranking provider and/or can be called up by the lower-ranking provider after a timeout, or the request for the service is forwarded at once and the lower-ranking provider can provide the service after the timeout, or a service provided at once by a lower-ranking provider is forwarded to the client after the timeout.

19. The method according to claim 1 wherein, in order to evaluate the providers and/or determine their ranking, service-specific quality parameter values of several providers are compared to each other and/or service-specific quality parameter values of the providers are compared to fixed setpoint values.
